(19) United States
(12) Patent Application Publication
(10) Pub. No.: US 2013/0132179 A1
(43) Pub. Date: May 23, 2013

(54) System and Method for Combining Group Buying with Regular Selling

(71) Applicants: Bo Wu, Beijing (CN); Chonghao Jiang, Beijing (CN); Jinghui Zhang, Beijing (CN); Guohua Lu, Beijing (CN); Yuhong Xiong, Beijing (CN)

(72) Inventors: Bo Wu, Beijing (CN); Chonghao Jiang, Beijing (CN); Jinghui Zhang, Beijing (CN); Guohua Lu, Beijing (CN); Yuhong Xiong, Beijing (CN)

(73) Assignee: LaShou Group Inc., Grand Cayman (KY)

(21) Appl. No.: 13/300,525

(22) Filed: Nov. 18, 2011

(51) Int. Cl. G06Q 30/02

(52) U.S. Cl. 705/14.23

(57) ABSTRACT

A system and method of combining group buying with regular selling is provided. A group-buying company advertises a first product for sale from a group-buying website. The first product is a group-buying deal with deep discount offered for a short period of time. The group-buying websites also provides recommendation information on one or more products based on the first product. The one or more recommended products are supplied by another non-group-buying company. Consumers are able to purchase the one or more recommended products from the group-buying website.

### TECHNICAL FIELD

The present invention relates generally to e-commerce and, more particularly, to system and method for cross-promotion of group-buying products with non-group-buying products.

### BACKGROUND

There are several models in B2C (business to consumer) commerce. A first model is the traditional brick and mortar stores and shops. In this model, consumers visit the stores to buy products or services (e.g., in a restaurant). Usually, most of the products or services are sold at regular price, with a small number of items sold at lower (promotional) price and for a limited time. This form of commerce has been in existence for thousands of years.

A second model is e-commerce via online websites and stores. A typical example of this is amazon.com, where consumers buy products online and receive the products through shipment. In general, this model does not cover local services (e.g., restaurants). The pricing structure is similar to brick and mortar stores in that most of the products are sold at regular price, with a small number of items sold at lower (promotional) price and for a limited time. This form of commerce has been in existence for the past two decades or so.

A third model is online group-buying. This is a model got popularized in the recent 2-3 years. It started by offering coupons for local services online, and more recently, has evolved to also cover delivered products at scale. Different from the above two models, all the products sold in a typical group-buying website are priced at deep discount, but a minimum number of buyers is required for a deal (the product or service being sold) to be valid. Another limitation of the group-buying model is that product selection at any particular time is limited. Compared with (possibly) hundreds of thousands of products on a regular e-commerce site, a group-buying website usually just has hundreds of products or less at any particular time.

In B2C commerce, recommendation is a very common technique. For example, when a customer buys a laptop, the merchant may recommend the customer to buy a mouse. In the online world, recommendations often appears as “Customer who bought this product also bought”, or “You may also like”. These recommendations are often computed base on sophisticated data mining algorithms, such as association rules, collaborative filtering, and/or personalization algorithms. Because of the importance of this technique, recommending systems has become a focused research area in recent years. Currently, however, recommendations on B2C websites are limited to products offered by the same website, and under the same B2C model. For example, a group-buying company may recommend other group-buying deals from the same company, and an online store may recommend other products from the same site.

### SUMMARY

A system and method of combining group buying with regular selling is provided. A group-buying company advertises a first product for sale from a group-buying website. The first product is a group-buying deal with deep discount offered for a short period of time. The group-buying websites also provides recommendation information on one or more products based on the first product. The one or more recommended products are supplied by another non-group-buying company. Consumers are able to purchase the one or more recommended products from the group-buying website.

In one embodiment, the non-group-buying company as a supplier opens up its inventory database to the group-buying company. The group-buying company determines the recommendation information based on data mining algorithms using the following information: relationship to the currently advertised group-buying product, personal information of the current buyer, collective buying behavior of users, and what is currently available in the inventory database. In addition, extended product selection is achieved by searching capability. Users can search the entire inventory database of the supplier from the same group-buying website and make payments from the same group-buying website.

In another embodiment, the non-group-buying company receives relevant information from the group-buying company and determines the recommendation information, which is sent back to the group-buying company. The non-group-buying company may have more control on the cross-promotion process including the payment process and even the display format of the recommendation.

In another preferred embodiment, the non-group-buying company is a local store that provides a large selection of products and services to local consumers. The recommended products/services may be determined based on buyer's location. After the buyer purchases a product or service from the group-buying website, the buyer gets a voucher or coupon code. The buyer then goes to the nearby local store to redeem the coupon (e.g., pick up the ordered product or enjoy the ordered service). This type of commerce model is a type of O2O (online-to-offline) transaction that has certain advantages by combining online and offline business, especially when location-based recommendation can be targeted to consumers located near the local store.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an online group-buying retail system in accordance with one novel aspect.

FIG. 2 illustrates one embodiment of a detailed online group-buying retail procedure with recommendation for non-group-buying products.

FIG. 3 illustrates an example of a group-buying website with recommendation for non-group-buying products.

FIG. 4 illustrates a first embodiment of combining group-buying with regular-selling.

FIG. 5 illustrates a second embodiment of combining group-buying with regular-selling.

FIG. 6 is a flow chart of one embodiment of a method of combining group-buying with regular-selling in accordance with one novel aspect.

### DETAILED DESCRIPTION

Reference will now be made in detail to some embodiments of the invention, examples of which are illustrated in the accompanying drawings.

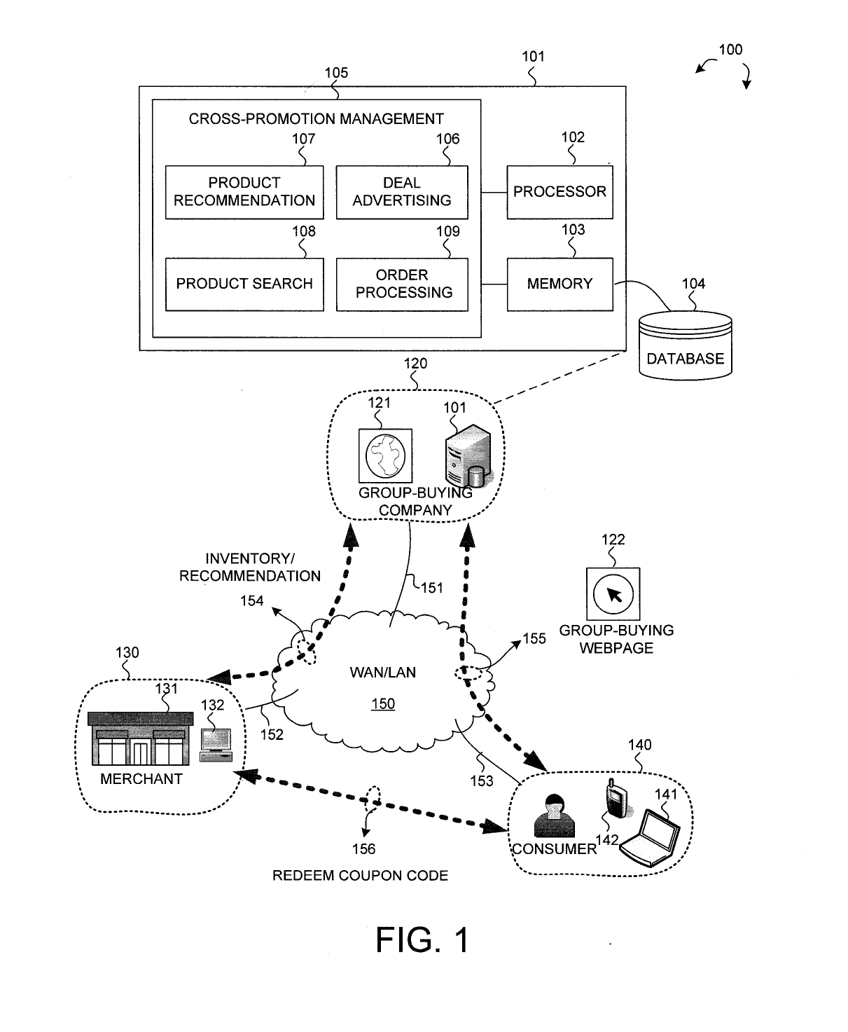

FIG. 1 illustrates an online group-buying system 100 in accordance with one novel aspect. Online group-buying system 100 comprises an online group-buying company 120, a plurality of merchants (e.g., merchant 130 as illustrated in FIG. 1), and a plurality of consumers (e.g., customer 140 as illustrated in FIG. 1). Online group-buying company 120 is an online seller that sells discounted products and services to large groups of consumers for sales campaigns made in a short duration of time via a group-buying website (e.g., website 121). For example, online group-buying company 120 uses a server computer 101 to implement a particular group-buying sales campaign. Merchant 130 is a supplier that supplies the discounted products and/or services to consumers via online group-buying company 120. In one example, merchant 130 has a local store that provides a variety of regular-selling products and/or services in addition to the discounted items sold through online group-buying company 120. In another example, some of the regular-selling items are recommended by website 121. Customer 140 is a buyer that purchases the discounted and/or recommended items from online group-buying company 120. For example, consumer 140 uses either a laptop client computer 141 or a mobile device (e.g., a mobile phone, or a personal digital assistant (PDA), etc.) 142 to browse the Internet via a webpage 122 for products and/or services advertised by online group-buying company 120. Note that the term “regular-selling” means “non-group-buying”. A regular-selling item is a non-group-buying item which may be sold at a regular price or a discount (promotional) price.

In the example of FIG. 1, online group-buying company 120 utilizes server computer 101 to provide discounted group-buying deals as well as recommend regular-selling items provided by merchant 130. Server computer 101 comprises a processor 102, memory 103 coupled to a permanent database 104, and an cross-promotion management module 105 comprising a deal-advertising module 106, a product-recommendation module 107, a product-search module 108, and an order-processing module 109. Deal-advertising module 106 advertises group-buying deals to consumers. Product-recommendation module 107 recommends group-buying and/or regular-selling products to consumers. Product search module 108 provides searching function to consumers. Order-processing module 109 receives and processes purchase orders from consumers.

The different modules within cross-promotion management module 105 are function modules that may be running on the same or different computer servers. The function modules, when executed by processor 102, allow online group-buying company 120 to advertise group-buying deals and recommend regular-selling products to consumers via communication between server computer 101 and other server computers. In one embodiment, various activities are performed by exchanging communication messages in online group-buying system 100 via WAN/LAN 150 (e.g., the computers are connected to WAN/LAN 150 via wired or wireless links 151, 152, and 153 respectively). In a first example, online group-buying company 120 receives inventory database from merchant 130 and exchanges recommendation information via communication between server computer 101 and server computer 132 (e.g., depicted by a dashed-line 154). In a second example, online group-buying company 120 advertises group-buying deals or recommends regular-selling products and delivers a coupon code to client computer 141 and/or mobile phone 142 for the sold item via webpage 122 (e.g., depicted by a dashed-line 155). In a third example, customer 140 redeems the coupon code for the purchased item provided by merchant 130 (e.g., depicted by a dashed-line 156). All the activities performed by the different parties—and all the information created and updated related to all the business transactions—are saved by server computer 101 onto DB104.

In one novel aspect, online group-buying company 120 combines group-buying deals with regular-selling products via cross-promotion management module 105. The online retailing method enables a group-buying company to cross promote non-group-buying products (e.g., products at regular price) on the group-buying website, and vice versa. The main benefit to consumers is extended product selection. Typically, a group-buying company only provides very limited (e.g., up to a few hundred) products from a group-buying site. With cross-promotion, consumers can enjoy the experience of selecting from hundreds of thousands or even more products from a single site. In the past, a store usually needs to make the trade-off between price and selection. If a store positions itself to offer good selection (e.g., Amazon.com), most products do not carry deep discounts, and this type of stores is suitable for “planned buying” (e.g., consumers know what they are looking for). On the other hand, if a store positions itself to offer good price (e.g., a group-buying site), the selection is limited, and this type of stores is suitable for “impulse buying” (e.g., consumers browse the products without clear intention before making purchases). By using the cross-promotion method, a consumer can go to a single site to browse good deals (impulse buying) as well as searching and finding any particular product through the same site (planned buying).

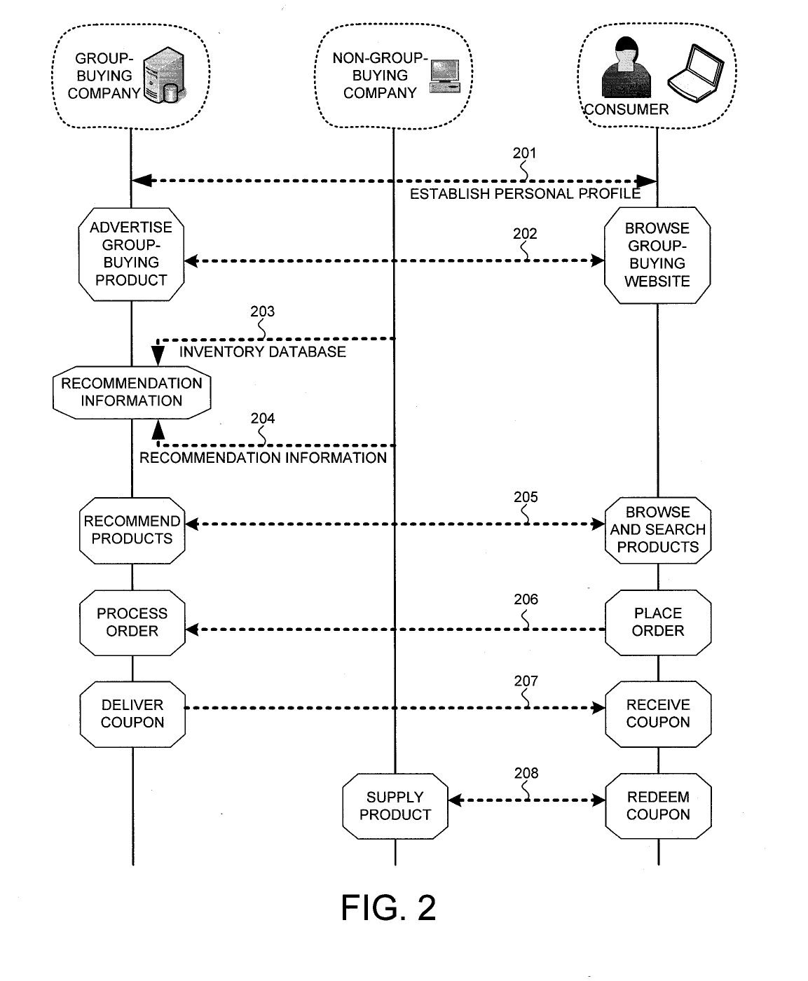

FIG. 2 illustrates one embodiment of a detailed online group-buying retail procedure with recommendation for non-group-buying products. In step 201, the online group-buying company establishes a personal profile database for all members/users of its group-buying website. The personal profile database may include basic information of the members/users and their buying behavior/preference. In step 202, the online group-buying company advertises group-buying deals from a server computer via the group-buying website, where potential buyers or subscribed members can browse the advertised deals via a web browser. In step 203, a non-group-buying company (e.g., a local store) opens up its inventory database to the group-buying company. Based on the group-buying deal, the buyer's personal profile, and the inventory database, the group-buying company determines recommendation information. Alternatively, in step 204, the local store receives certain information from the group-buying company and provides recommendation information back to the group-buying company without providing its inventory database. In step 205, a buyer browses the website for recommended products and optionally searches for more products. In step 206, the buyer places a purchase order, and the server computer processes the purchase order. In step 207, the buyer receives a voucher or a coupon code delivered by the online group-buying company. In step 208, the buyer redeems the coupon, and the purchased product can be picked up from the local store or delivered to the buyer after validation of the coupon.

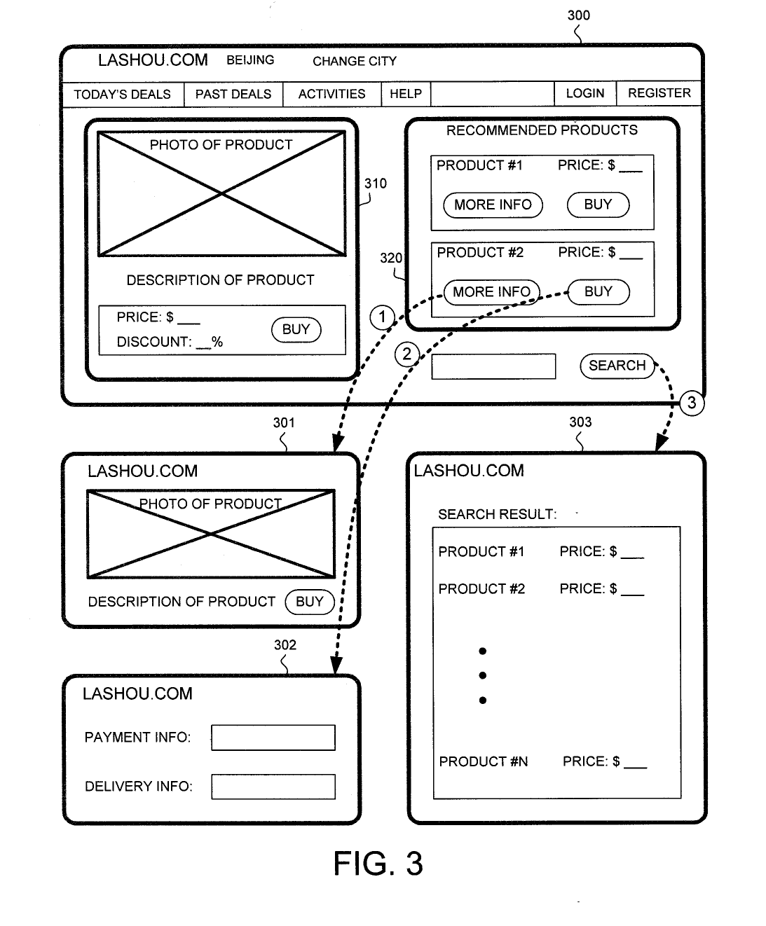

FIG. 3 illustrates an example of a group-buying webpage 300 with product recommendation for non-group-buying products. Webpage 300 is a product webpage from a group-buying website of a group-buying company. At the left side of webpage 300, box 310 advertises a discounted product with photo, description, price, and discount information. The discounted product is supplied by merchant A. At the right side of the webpage 300, box 320 recommends two regular-selling products with product name and price information. The recommended products #1 and #2 are provided by a non-group-buying company (e.g., the same merchant A or a different merchant B). For each of the recommended products, there is a “more info” button and a “buy” button. When a user clicks on the “more info” button, the user is taken to another webpage 301 (e.g., depicted by link #1). Webpage 301 displays additional product information such as photos and descriptions of the product at interest. When a user clicks the “buy” button, the user is taken to another webpage 302 (e.g., depicted by link #2). Webpage 302 prompts the user for payment and delivery information and process the purchase order accordingly. Webpage 301 may also contain the “buy” button that takes the user to webpage 302 for purchase order processing.

There are several variations and extensions to the above-described cross-promotion method. In one example, when the user clicks on the recommended product, the user is taken to webpage 301 for more product information or webpage 302 for payment information from the same group-buying website. In another example, the user is taken to a different target website to view more product information and/or to make payment. The target website is usually the site of the original product seller, or manufacturer, or service provider of the recommended product (e.g., merchant A or merchant B). The recommendation may be placed in other areas of webpage 300, such as the left side or the bottom, and may be placed in other webpages such as the home page and the payment page. There may be more than one recommendation boxes on the webpage, and the number of recommended products may vary. The recommended products may be a delivered product, or a local service, or a coupon for buying the product or service. Instead of buying products or services in the recommendation box directly, consumers may also be able to click a button (not shown) on the webpage to call/text the service provider to make reservations or ask questions.

Another major extension of the cross-promotion method is the search capability. For typically group-buying companies, product selection is very limited due to limited “shelf space” because of the nature of group-buying—products are offered for sale with very deep discount for a very short period of time (e.g., a few days or a week). As a result, a group-buying website typically does not need to support the search function. With cross-promotion, the search function becomes important because it enables extended product selection for consumers. A consumer can go to a single website to purchase a deeply discounted group-buying product as well as find any particular regular-selling product through a simple search. In the example of FIG. 3, a “search” button is placed on webpage 300. When a user clicks the “search” button, the corresponding search result is displayed on another webpage 303 (e.g., depicted by link #3). The search result can include both group-buying products and regular-selling products.

The cross-promotion method requires cooperation between the group-buying company and the non-group-buying company that supplies the products. Currently in the group-buying industry, the way it works is that the group-buying company works with its supplier to identify/design one or a few products and offers them as group-buying deals to consumers. A few examples include: a group-buying company works with a restaurant to “design” a four-people set meal that includes four entrees and some desert, and sells the set meal as a deal; a group-buying company works with a luxury goods retailer to select a particular watch and offers it as a deal; a group-buying company works with a regular online store and offers a “$2 for $10” coupon for the store as a deal. In all of these cases, consumers only see the advertised deals on the group-buying site, and the other products or services offered by the same supplier are not available on the group-buying site. In one novel aspect, the group-buying company negotiates with its supplier to open its inventory database to the group-buying company, so that the group-buying company can recommend and sell any products in the inventory.

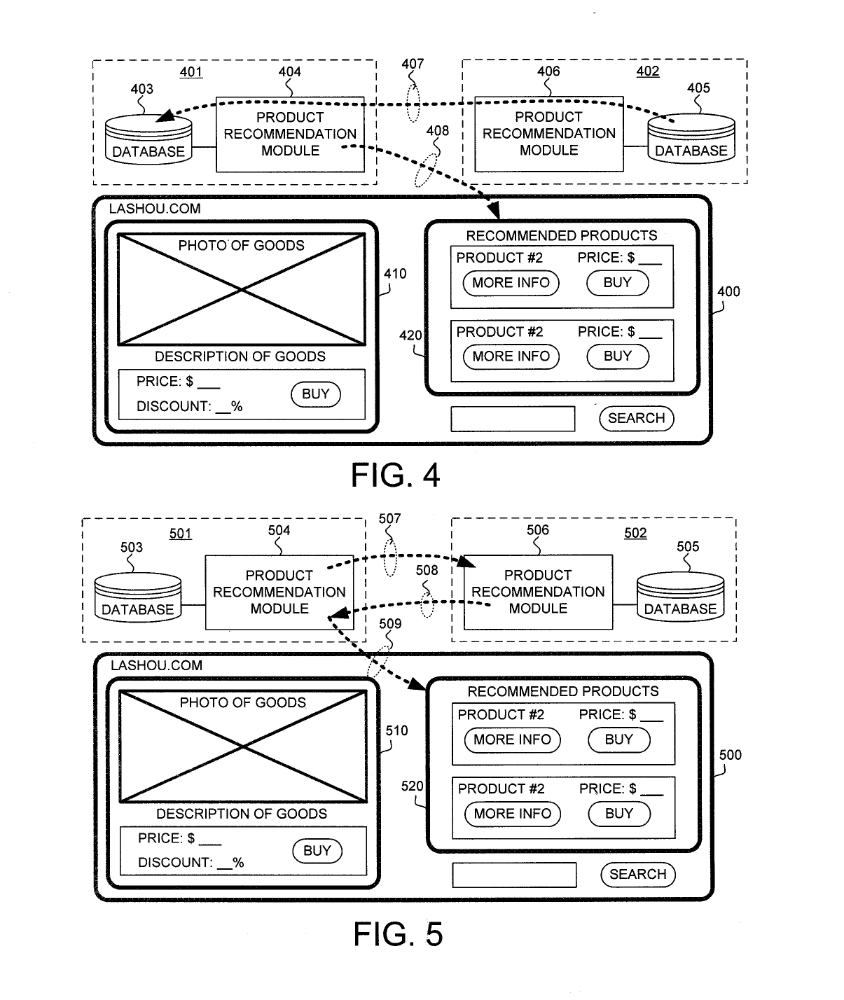

FIG. 4 illustrates a first embodiment of combining group-buying with regular-selling via a group-buying webpage 400. In the example of FIG. 4, a group-buying company negotiates with its supplier for group-buying deals and for cross-promotion products. The group-buying company uses a server computer 401 to communicate with another server computer 402 of its supplier. The supplier is a non-group-buying company (e.g., a local department store) that sells a large selection of products and services. Server computer 401 has an inventory database 403 and a product recommendation module 404. Similarly, server computer 402 has an inventory database 405 and a product recommendation module 406. For group-buying deals, box 410 on webpage 400 advertises a discounted product with photo, description, price, and discount information. The discounted product is supplied by the supplier. For cross-promotion, box 420 on webpage 400 recommends two regular-selling products with product name and price information, as well as “more info” button and “buy” button. The recommended products are supplied by the same supplier (e.g., the local department store).

There are different ways in determining and providing recommendation information. In one embodiment illustrated in FIG. 4, the supplier opens up its inventory database to the group-buying company (e.g., the inventory database is transferred from database 405 of the supplier to database 403 of the group-buying company, as depicted by dashed-line 407). The product recommendation module 404 then determines the recommendation information using sophisticated data-mining algorithms (e.g., based on the recommendation information, the recommended products are displayed in box 420, as depicted by dashed-line 408). The recommended products are determined based on the following information: relationship to the currently advertised group-buying product, personal information of the current buyer (past buying history, age, gender, location, etc.), collective buying behavior of users (users who have viewed this product also viewed what other products, what products are currently hot, etc.), and what is currently available in the inventory database. As a result, users that are currently browsing the group-buying website will most likely be highly interested in the recommended products. In addition, users can search the entire inventory database of the supplier from the same website and make payments from the same website. It is beneficial to members/users of the group-buying website to be able to browse good deals (impulse buying) as well as searching and finding any particular product (planned buying) through the same website without going to other unfamiliar/non-trustable websites.

FIG. 5 illustrates a second embodiment of combining group-buying with regular-selling via a group-buying webpage 500. Like FIG. 4, in the example of FIG. 5, a group-buying company negotiates with its supplier for group-buying deals and for cross-promotion products. The group-buying company uses a server computer 501 to communicate with another server computer 502 of its supplier. The supplier is a non-group-buying company (e.g., a local department store) that sells a large selection of products and services. Server computer 501 has an inventory database 503 and a product recommendation module 504. Similarly, server computer 502 has an inventory database 505 and a product recommendation module 506. For group-buying deals, box 510 on webpage 500 advertises a discounted product with photo, description, price, and discount information. The discounted product is supplied by the supplier. For cross-promotion, box 520 on webpage 500 recommends two regular-selling products with product name and price information, as well as “more info” button and “buy” button. The recommended products are supplied by the same supplier.

Unlike FIG. 4, in the example of FIG. 5, the supplier determines the recommendation information. This is because in some situations, a supplier of a group-buying company may not want to open up its entire inventory database to the group-buying company. As illustrated in FIG. 5, product recommendation module 504 of the group-buying company first sends relevant information to product recommendation module 506 of the supplier. The relevant information may include information of the currently advertised group-buying deal, the number of recommended products, personal information of the buyer, and collective buying behavior of users (e.g., as depicted by dashed-line 507). For example, the group-buying company may tell the supplier that “I have three product displays for you. These three places are on the right-hand-side column on a page that features a laptop computer deal, and the user viewing the page is a male between 20-30 years old, who has bought a lot of high tech products in the past.” Based on this information, product recommendation module 506 determines the recommended products and sends the recommendation information back to server 501 (e.g., as depicted by dashed-line 508). Finally, the recommended products are displayed in box 520 based on the recommendation information (e.g., as depicted by dashed-line 509). In this embodiment, the supplier may want to have more control over the cross-promotion process. For example, when users click the “more info” button and the “buy” button, the users will be taken to a different website, i.e., by the supplier. In addition, the product recommendation area may become a “plug-in” in that the display format of the recommended products is also controlled by the supplier.

Because the group-buying company and the supplied work together to make profit from the cross-promoted products, they can use any preferred payment model between them, such as cost per thousand impressions (CPM), cost per click (CPC), or cost per sales (CPS). In addition, the payment process can also have different variations. In one example, the payment process becomes a “plug-in”, so that when a consumer makes a payment, part or all of the sales proceeds go directly to the supplier's account. In another example, when a consumer makes a payment, all of the sales proceeds are held by a third party escrow account. Later on, the fund in the escrow account is split between the group-buying company and its supplier.

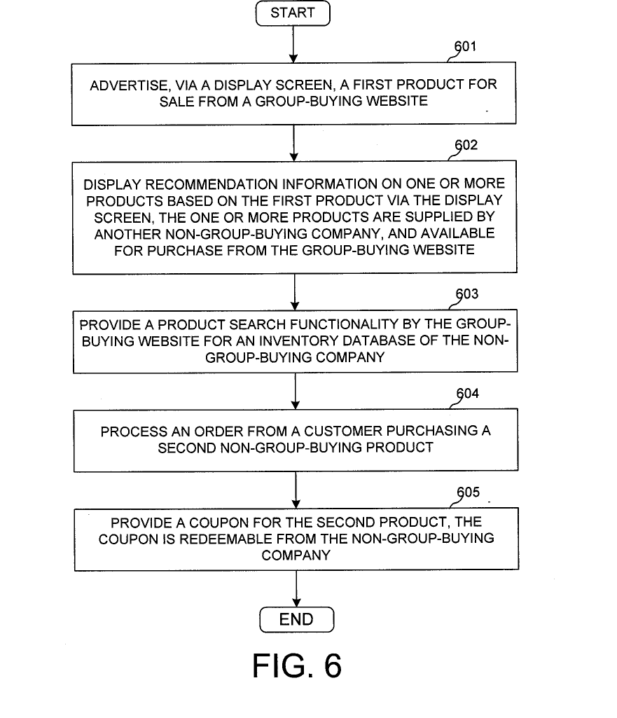

FIG. 6 is a flow chart of one embodiment of a method of combining group-buying with regular-selling in accordance with one novel aspect. In step 601, a group-buying company advertises a first product via a group-buying website. The first product is a group-buying deal with deep discount offered for a short period of time. In step 602, the website displays recommendation information for one or more non-group-buying products based on the first group-buying product. The one or more recommended products are supplied by another non-group-buying company and are available for purchase from the group-buying website. In step 603, the group-buying website provides search functionality for an inventory database of the non-group-buying company. In step 604, the group-buying website processes an order from a customer purchasing a second non-group-buying product. In step 605, the group-buying website provides a coupon code for the second product, and the coupon is redeemable from the non-group-buying company.

In one preferred embodiment, the non-group-buying company is a local supplier that supplies the group-buying product/service. The local supplier also has a local department store that sells a much larger selection of products and services. The local department store first negotiates with the group-buying company to offer group-buying deals. In addition, the local department store also opens up its inventory database to the group-buying company for cross-promotion. In one example, when a buyer browses for group-buying deals from the group-buying website, other related products available from the local department store are recommended to the buyers. In addition, the buyer is able to search the entire inventory database of the local department store. In one specific embodiment, the local department store is located near the buyer. After the buyer purchases a product or service from the group-buying website, the buyer gets a voucher or coupon code. The buyer then goes to the local department store to redeem the coupon (e.g., pick up the ordered product or enjoy the ordered service).

This type of commerce model is a type of O2O (online-to-offline) transaction that covers offline commerce. O2O has certain advantages by combining online and offline business because the recommended products may be determined based on buyer's location. Because regular-selling products are recommended to local customers near the department store, it is more likely to attract more customers because of the convenient location (e.g., no shipping cost, being able to try at the store, and guaranteed availability, etc.). Furthermore, under this model, the group-buying company can also provide value-added services to its suppliers. For example, through data mining, the group-buying company may discover that a particular supplier should offer a particular slow-selling product as a group-buying deal to make room for more popular products, and pass this advice to the supplier as value-added service.

In one or more exemplary embodiments, the functions described above may be implemented in hardware, software, firmware, or any combination thereof. If implemented in software, the functions may be stored on or transmitted over as one or more instructions or code on a computer-readable (processor-readable) medium. Computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that both can be used to carry or store desired program code in the form of instructions or data structures, and can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

Although the present invention has been described in connection with certain specific embodiments for instructional purposes, the present invention is not limited thereto. For example, the idea of combining group-buying and non-group-buying products can be adopted by non-group-buying sites. That is, a regular e-commerce site can display group-buying products together with regular products. Accordingly, various modifications, adaptations, and combinations of various features of the described embodiments can be practiced without departing from the scope of the invention as set forth in the claims.

1. A computer-implemented method, comprising:
advertising, via a display screen, a first product for sale from a group-buying website, wherein the first product is a group-buying deal with discount from original pricing offered for a period of time of less than a week; and
displaying cross-promotion recommendation information on one or more products based on the first product via the same display screen, wherein the one or more products are supplied by another non-group-buying company, and wherein the one or more products are available for purchase from the group-buying website.

2. The method of claim 1, wherein the one or more recommended products are determined based on personal behavior of the customer and collective behavior of buyers.

3. The method of claim 1, wherein the recommendation information is associated with a link to additional information of the recommended products from the group-buying website.

4. The method of claim 1, wherein the recommendation information is associated with a link to payment, and wherein the consumer makes payment directly from the group-buying website.

5. The method of claim 1, wherein the second product is a coupon, and wherein the coupon is redeemable from a local store of the non-group-buying company located near the consumer, and wherein the cross-promotion recommendation information is determined based at least in part on location information of the consumer and the local store.

6. The method of claim 1, further comprising:
providing a product search functionality by the group-buying website for an inventory database of the non-group-buying company.

7. The method of claim 1, further comprising:
providing information of the first product to the non-group-buying company; and
receiving the recommendation information from the non-group-buying company.

8. A server system, comprising:
an advertisement module that advertises a first product for sale from a group-buying website via a display screen, wherein the first product is a group-buying deal with discount from original pricing offered for a period of time of less than a week; and
a product recommendation module that provides cross-promotion recommendation information on one or more products based on the first product via the same display screen, wherein the one or more products are supplied by another non-group-buying company, and wherein the one or more products are available for purchase from the group-buying website.

9. The server of claim 8, wherein the one or more recommended products are determined based on personal behavior of the customer and collective behavior of buyers.

10. The server of claim 8, wherein the recommendation information is associated with a link to additional information of the recommended products from the group-buying website.

11. The server of claim 8, wherein the recommendation information is associated with a link to payment, and wherein the consumer makes payment directly from the group-buying website.

12. The server of claim 8, wherein the second product is a coupon, and wherein the coupon is redeemable from a local store of the non-group-buying company located near the consumer, and wherein the cross-promotion recommendation information is determined based at least in part on location information of the consumer and the local store.

13. The server of claim 8, further comprising:
a product search module that provides a product search functionality by the group-buying website for an inventory database of the non-group-buying company.

14. The server of claim 8, wherein the recommendation module provides information of the first product to the non-group-buying company and in response receives the recommendation information from the non-group-buying company.

15. A computer-readable medium storing instructions that, when executed by a processor, cause the processor to perform a method, the method comprising:
advertising, via a display screen, a first product for sale from a group-buying website, wherein the first product is a group-buying deal with discount from original pricing offered for a period of time of less than a week; and
displaying cross-promotion recommendation information on one or more products based on the first product via the same display screen, wherein the one or more products are supplied by another non-group-buying company, wherein the one or more products are available for purchase from the group-buying website.

16. The computer-readable medium of claim 15, wherein the one or more recommended products are determined based on personal behavior of the customer and collective behavior of buyers.

17. The computer-readable medium of claim 15, wherein the recommendation information is associated with a link to additional information of the recommended products from the group-buying website.

18. The computer-readable medium of claim 15, wherein the recommendation information is associated with a link to payment, and wherein the consumer makes payment directly from the group-buying website.

19. The computer-readable medium of claim 15, wherein the second product is a coupon, and wherein the coupon is redeemable from a local store of the non-group-buying company located near the consumer, and wherein the cross-promotion recommendation information is determined based at least in part on location information of the consumer and the local store.

20. The computer-readable medium of claim 15, the method further comprising:
providing a product search functionality by the group-buying website for an inventory database of the non-group-buying company.

21. The computer-readable medium of claim 15, the method further comprising:
providing information of the first product to the non-group-buying company; and
receiving the recommendation information from the non-group-buying company.
